(19) United States
(12) Patent Application Publication
(10) Pub. No.: US 2010/0266862 A1
(43) Pub. Date: Oct. 21, 2010

(54) METAL PARTICLE TRANSFER ARTICLE, METAL MODIFIED SUBSTRATE, AND METHOD OF MAKING AND USING THE SAME

(75) Inventors: Paul S. Lugg, Woodbury, MN (US); Timothy D. Fletcher, Lino Lakes, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/760,992

(22) Filed: Apr. 15, 2010

Related U.S. Application Data
(60) Provisional application No. 61/170,131, filed on Apr. 17, 2009.

(51) Int. Cl. B32B 15/02; B32B 15/04; B22F 7/04; B32B 38/10; B24B 1/00

(52) U.S. Cl. 428/551; 428/548; 156/62.2; 451/36

(57) ABSTRACT

A metal particle transfer article and a metal modified substrate are provided as well as methods of making and using the article and substrate.

### CROSS REFERENCE TO RELATED APPLICATION

This application claims the benefit of U.S. Provisional Patent Application No. 61/170,131, filed Apr. 17, 2009, the disclosure of which is incorporated by reference herein in its entirety.

### SUMMARY

There is a desire to produce articles for packaging, protection and storage of metal particles in a film format and for eventual delivery of a monolayer of these metal particles onto a substrate, which may be rigid, for example, a precisely planar rigid lapping surface, or flexible, to create a metal modified substrate. When rigid substrates are used, a lapping substrates or plates may be produced. The present disclosure provides a streamlined and economically efficient solution to create such transfer articles and metal modified substrates or plates. The metal modified substrate can then be used with abrasive particles, for example, a slurry, to function as an abrasive article.

As used herein, the term “fixed article” generally refers to a condition where the metal particles are fixed in a cured, first binder (sometimes referred to those skilled in the abrasive art as a “make coat”) and optionally a cured second binder (sometimes referred to those skilled in the abrasive art as a “size coat”). The term “cured” encompasses partially cure or fully cured condition of the first and or second binder. The term “partially cured” means a condition of the resinous binder in which the resin has begun to polymerize and has experienced an increase in molecular weight, but in which the resin continues to be at least partially soluble in an appropriate solvent. The term “fully cured” means a condition of the resinous binder in which the resin is polymerized and is in a solid state and in which the resin is not soluble in a solvent.

In one aspect, the present disclosure relates to a metal particle transfer article comprising a first liner having opposing first and second surfaces, wherein the first surface has a release value of less than about 700 gram per inch per ASTM D3330/D3330M-04; and a layer of metal particles disposed on the first surface of the first liner.

In another aspect, the present disclosure relates to a method of making a metal modified substrate or article comprising the steps of providing a rigid substrate having opposing first and second surfaces; coating a first binder on the first surface of the rigid substrate; providing a metal particle transfer article comprising a first liner having opposing first and second surfaces, wherein the first surface has a release value of less than about 700 gram per inch per ASTM D3330/D3330M-04, and a layer of metal particles disposed on the first surface of the first liner; applying the metal particle transfer article to the first surface of the rigid substrate wherein the metal particles are in contact with the first binder; removing the first liner from the rigid substrate; and curing the first binder thereby securing the metal particles to the first surface of the rigid substrate.

In yet another aspect, the present disclosure relates to a metal modified substrate comprising a rigid substrate having a first and a second surface, a first binder on the first surface of the substrate, and a layer of metal particles disposed in the first binder.

In yet another aspect, the present disclosure relates to a metal modified substrate comprising a rigid substrate having a first and a second surface, a first binder on the first surface of the substrate, and a layer of metal particles disposed in the first binder, wherein the layer comprises at least two concentric regions on the first binder, wherein at least one concentric region comprises metal particles having a feature which differs from a feature of metal particles of at least one other concentric region.

In another aspect, the present disclosure relates to a metal modified substrate comprising a rigid substrate having a first and a second surface, a first binder on the first surface of the substrate, a layer of metal particles disposed in the first binder of the first surface, a first binder on the second surface of the substrate, and a layer of metal particles disposed in the first binder of the second surface.

In yet another aspect, the present disclosure relates to a method of polishing a workpiece comprising attaching a workpiece to a stationary article that allows the workpiece to rotate, applying a metal modified substrate to the workpiece in the presence of an abrasive slurry, and abrading the workpiece.

In particular, the inventor of the present disclosure recognized and took advantage of the electrostatic force that is present in a release liner, whether such liner is based on paper, polymeric film including non-woven films or fabric, to temporarily bond the metal particles to the liner. The electrostatic attraction between the transfer liner and the metal particles, however, is not so strong that the particles will not release from the liner. Furthermore, the metal particles of the present disclosure are not embedded in the release liner but instead cling to the release coating side of the release liner.

In one application, metal modified substrates, for example, prepared from transfer articles disclosed herein, can be used to polish, abrade or finish an article (sometimes referred to in the industry as a “workpiece”). In some applications, it is very desirable that an article used to polish, abrade or finish a workpiece is substantially flat and remains substantially flat during polishing. If there is unevenness, asperities, or waviness in the article, its use during polishing may lead to crowning or “roll off” of the work piece. Crowning is undesirable rounding of the work piece edges. One advantage of the present disclosure is that starting with a substantially flat and preferably rigid substrate provides an efficient and cost effective way to prepare a polishing, abrading or finishing article. Furthermore, using a transfer article allows for immense flexibility because the metal particles can be applied to a substrate of varying geometry. So long as the transfer article is flexible, it can conform to the shape of a substrate, particularly a rigid substrate.

### BRIEF DESCRIPTION OF THE DRAWINGS

The invention will be further described with reference to the following drawings, wherein:

FIG. 1 is a schematic cross-sectional view of a transfer article according to one aspect of the present disclosure;

FIG. 2 is a schematic cross-sectional view of an exemplary method of making an abrasive article according to one aspect of the present disclosure;

FIG. 3 is a perspective view of a roll of transfer article according to one aspect of the present disclosure;

FIG. 4 is a perspective view of transfer article with concentric regions of varying metal particle density;

FIG. 4a is a perspective view of transfer article with concentric regions of varying metal particle density where one region is discontinuous;

FIG. 5 is a schematic cross-sectional view of a metal modified substrate, having metal particles on both sides of the substrate, attached to a tool platen;

FIG. 6 is a photograph of 100 micron tin/bismuth spheres electrostatically attached to a release liner;

FIG. 7 is a photograph of Platen A made from a transfer article of Example 1 after polishing a sapphire workpiece for several hours;

FIG. 8 is a chart showing the removal in grams versus polish time for the articles produced and employed in the Examples section;

FIG. 9 is a photograph of a platen with concentric regions of varying metal particle density; and

FIG. 10 is a photograph of the same platen of FIG. 9. at a closer view showing varying metal particle density.

These figures are illustrative, are not drawn to scale, and are intended merely for illustrative purposes.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5). All parts recited herein, including those in the Example section below, are by weight unless otherwise indicated.

### Transfer Article

A transfer article comprises at least a first liner and a layer of metal particles. A transfer article may be in the form of a roll (and subsequently converted into sheets and disks) or may be in the form of a sheet or disk. Transfer articles may be used to modify a substrate, both rigid and flexible, with a unique surface distribution of precisely shaped, precisely placed metal particles. Exemplary rigid substrates include annular rigid platens.

Transfer articles of the present disclosure provide a new technique for surface modifying and resurfacing articles such as ductile metal platens. Traditional methods such as die coating or knife coating of liquid dispersion may not be suitable to coat discontinuous rigid surfaces such as annular platens. Transfer articles described herein utilize the benefits of roll to roll coating on thin flexible films and may be useful to modify the surface of a precise and rigid surface such as a metal lapping/polishing platen.

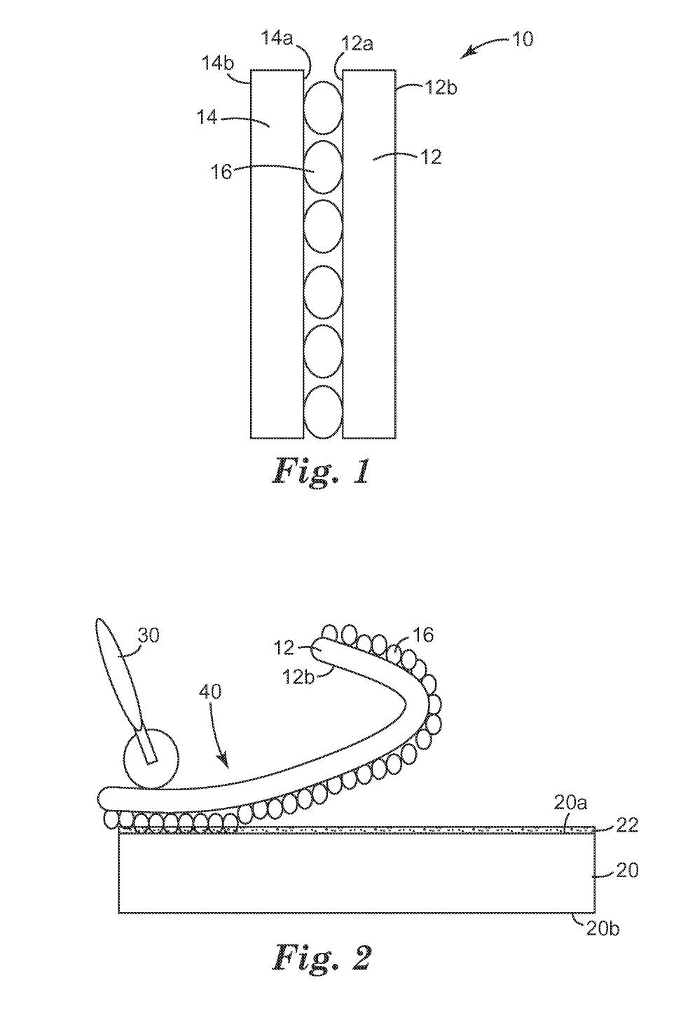

With reference to the figures, FIG. 1 shows a schematic cross-sectional view of an exemplary dual liner transfer article 10 having a first liner 12, a second liner 14, and metal particles 16 disposed or sandwiched between the two liners. Each of the first and second liner has a first surface 12a and 14a respectively and an opposing second surface 12b and 14b respectively. A release coating (not shown) is disposed on the first surface 12a of the first liner and optionally on the first surface of 14a of the second liner. The metal particles are adhered to the liner by electrostatic forces.

Another embodiment of the present disclosure includes multiple layers of release liner and metal particles. For example, a transfer article may comprise a first liner having a first and second surface; a first layer of metal particles disposed on the first surface of the first liner; a second liner, having a first and second surface, disposed on the layer of metal particles wherein the first surface of the second liner is in contact with the metal particles; a second layer of metal particles disposed on the second surface of the second liner, and optionally a third liner, having a first and second surface, wherein the first surface of the third liner is in contact with the second layer of metal particles. The number of layers of liners and the number of layers of metal particles can be selected based on the desired end use.

Optionally, a particulate vitrifiable binder (not shown), which is described herein, can be disposed between the first and second liners. The particulate vitrifiable binder can be a thermoplastic or a thermosetting resin. Additionally, abrasive particles or abrasive powder (not shown) may also be disposed on the first liner in addition to the metal particles and any optional particulate vitrifiable binder or powder. As used herein, a “powder” can include abrasive particles, a particulate vitrifiable binder, and combinations thereof. The particulates of the particulate binder and/or the abrasive particles may be of a size that is smaller than, the same as, or larger than the metal particles.

FIG. 3 shows a perspective view a roll of transfer article 50 according to one aspect of the present disclosure, similar to that of a roll of tape. The roll of transfer article 50 includes a single liner 52 having opposing first surface 52a and second surface 52b, with a release coating (not shown) disposed on the first surface 52a. Metal particles 56 and optional vitrifiable binder material (not shown) are disposed on the first surface 52a. Optionally, a second release coating (not shown) is also disposed on the second surface 52b of the liner, the second release coating having a lower release value than the first release coating thereby promoting the unwinding of the roll and minimizing if not eliminating the possibility of the abrasive particles (and any vitrifiable binder material if used) remaining with the second surface 52b of the liner.

### Materials for the First and Optional Second Liner

The type of release liner suitable for use in the present disclosure is not limited, so long as the liner can cause an electrostatic attraction to or electrostatic adhesion between it and the abrasive particles thereby allowing the abrasive particles to remain or cling to the liner. As discussed with reference to the drawings above, the liner has a release coating disposed on its first surface.

In one embodiment, the liner is a flexible backing. Exemplary flexible backings include densified Kraft paper (such as those commercially available from Loparex North America, Willowbrook, Ill.), poly-coated paper such as polyethylene coated Kraft paper, and polymeric film. Suitable polymeric film includes polyester, polycarbonate, polypropylene, polyethylene, cellulose, polyamide, polyimide, polysilicone, polytetrafluoroethylene, polyethylenephthathalate, polyvinylchloride, and polycarbonate. Nonwoven or woven liners may also be useful. Embodiments with a nonwoven or woven liner could incorporate a release coating.

In one embodiment, the release coating of the liner has a release value of less than about 700 gram per inch. Various test method can be used to measure this release value, such as for example ASTM D3330/D3330M-04.

In another embodiment, the release coating of the liner may be fluorine containing material, a silicon containing material, a fluoropolymer, a silicone polymer, or a poly (meth)acrylate ester derived from a monomer comprising an alkyl (meth)acrylate having an alkyl group with 12 to 30 carbon atoms. In one embodiment, the alkyl group can be branched. Illustrative examples of useful fluoropolymers and silicone polymers can be found in U.S. Pat. Nos. 4,472,480, 4,567,073, and 4,614,667. Illustrative example of a useful poly (meth)acrylate ester can be found in U.S. Patent Application Publication No. US 2005/118352.

In one embodiment, a first surface of the liner on which the metal particles are to be disposed may be textured so that at least one plane of the first surface of the liner is higher than another plane. The textured surface may be patterned or random. The highest plane or planes of the textured surface may be designated as the “delivery plane” since the highest plane or planes will deliver the metal particles to a substrate. The lower plane or planes may be designated as “recessed planes.”

### Metal Particles

Suitable metal particles include tin, copper, indium, zinc, bismuth, lead, antimony, and silver, and alloys thereof, as well as combinations thereof. Typically, the metal particles are ductile. Exemplary metal particles include tin/bismuth metal beads, which are commercially available from Indium Corporation, Utica, N.Y., as tin bismuth eutectic powder under the trade designation “58Bi42Sn Mesh100+200 IPN+79996Y” and copper particles (99% 200 mesh) commercially available from Sigma-Aldrich, Milwaukee, Wis., under catalog no. 20778.

A suitable particle size depends on the ultimate application of the article being produced. The transfer article may comprise metal particles of different sizes. An exemplary average particle size of the metal particles may be less than 200 microns, preferably between about 70 and 150 microns. The size of the metal particle is typically specified to be its longest dimension. In many instances it is preferred that the particle size distribution be controlled such that the resulting article provides a consistent surface finish on the workpiece being abraded.

Metal particles can be coated with materials to provide the particles with desired characteristics. For example, materials applied to the surface of a metal particle have been shown to improve the adhesion between the metal particle and the release liner. Additionally, a material applied to the surface of a metal particle may improve the adhesion of the metal particles in the softened particulate curable binder material. Alternatively, surface coatings can alter and improve the cutting characteristics of the resulting abrasive particle. Such surface coatings are described, for example, in U.S. Pat. Nos. 5,011,508 (Wald et al.); 3,041,156 (Rowse et al.); 5,009,675 (Kunz et al.); 4,997,461 (Markhoff-Matheny et al.); 5,213,591 (Celikkaya et al.); 5,085,671 (Martin et al.) and 5,042,991 (Kunz et al.).

Metal particles themselves may be modified, for example, to change shape or composition. For example, after a transfer article comprising metal particles is prepared using two liners, the transfer article can be put through high pressure nip rollers to flatten the metal particles. Also, after metal particles have been transferred from a transfer article to a metal modified substrate, a metal modified substrate can be subjected to direct pressure, for example, by using dressing rings or a sacrificial workpiece, to flatten the metal particles before the substrate is used on the desired workpiece. In another embodiment, the surface of the metal particles on a metal modified substrate can be modified, for example, by charging with an abrasive slurry to embed abrasive particles in the surface of the metal particles. Suitable abrasive slurries include slurries comprising diamond, silica, alumina, silicon carbide, and those described in PCT International Publication No. WO 2009/046296, incorporated herein by reference.

Metal particles disposed on a liner may be the same or different, for example, in terms of size, shape, composition, and/or properties (such as mechanical, optical, or electrical).

### Optional Abrasive Particles

Abrasive particles may be used in addition to metal particles and may be disposed on a first surface of a liner along with metal particles. Suitable abrasive particles that can be used in the present disclosure include fused aluminum oxide, heat treated aluminum oxide, white fused aluminum oxide, black silicon carbide, green silicon carbide, titanium diboride, boron carbide, tungsten carbide, titanium carbide, diamond (both natural and synthetic), silica, iron oxide, chromia, ceria, zirconia, titania, silicates, tin oxide, cubic boron nitride, garnet, fused alumina zirconia, sol gel abrasive particles and the like. Examples of sol gel abrasive particles can be found in U.S. Pat. Nos. 4,314,827 (Leitheiser et al.); 4,623,364 (Cottringer et al); 4,744,802 (Schwabel); 4,770,671 (Monroe et al.) and 4,881,951 (Wood et al.), all incorporated herein by reference.

As used herein, the term “abrasive particle” also encompasses single abrasive particles bonded together with a polymer, a ceramic, a metal or a glass to form abrasive agglomerates. The term “abrasive agglomerate” includes, but is not limited to, abrasive/silicon oxide agglomerates that may or may not have the silicon oxide densified by an annealing step at elevated temperatures. Abrasive agglomerates are further described in U.S. Pat. Nos. 4,311,489 (Kressner); 4,652,275 (Bloecher et al.); 4,799,939 (Bloecher et al.), 5,500,273 (Holmes et al.), 6,645,624 (Adefris et al.); 7,044,835 (Mujumdar et al.). Alternatively, the abrasive particles may be bonded together by inter-particle attractive forces as describe in U.S. Pat. No. 5,201,916 (Berg, et al.). Preferred abrasive agglomerates include agglomerates having diamond as the abrasive particle and silicon oxide as the bonding component. When an agglomerate is use, the size of the single abrasive particle contained within the agglomerate can range from 0.1 to 50 micrometer (μm) (0.0039 to 2.0 mils), preferably from 0.2 to 20 μm (0.0079 to 0.79 mils) and most preferably between 0.5 to 5 μm (0.020 to 0.20 mils).

The average particle size of the abrasive particles is typically less than 150 μm (5.9 mils), preferably less than 100 μm (3.9 mils), and most preferably less than 50 μm (2.0 mils). The size of the abrasive particle is typically specified to be its longest dimension. Typically, there will be a range distribution of particle sizes. In some instances it is preferred that the particle size distribution be tightly controlled such that the resulting abrasive article provides a consistent surface finish on the work piece being abraded.

The abrasive particle may also have a shape associated with it. Examples of such shapes include rods, triangles, pyramids, cones, solid spheres, hollow spheres and the like. Alternatively, the abrasive particle may be randomly shaped.

Yet another useful type of abrasive particle is a metal-based abrasive particle having a substantially spheroid metal containing matrix having a circumference and a super-abrasive materials having an average diameter of less than 8 μm at least partially embedded in the circumference of the metal containing matrix. Such abrasive particles can be made by charging into a vessel, metal-containing matrix (predominantly spheroids), super-abrasive particles, and grinding media. The vessel is then milled for a period of time, typically at room temperature. It is believed that the milling process forces the super abrasive material to penetrate into, attach to, and protrude from the metal containing matrix. The circumference of the metal containing matrix changes from pure metal or metal alloy to a composite of super abrasive and metal or metal alloy. The subsurface of the metal containing matrix near the circumference also contains the super abrasive material, which would be considered as being embedded in the metal containing matrix. This metal-based abrasive particle is disclosed in assignee's co-pending Provisional Patent Application No. 61/077,929, filed on Jul. 3, 2008.

Abrasive particles can be coated with materials to provide the particles with desired characteristics. For example, materials applied to the surface of an abrasive particle have been shown to improve the adhesion between the abrasive particle and the polymer. Additionally, a material applied to the surface of an abrasive particle may improve the adhesion of the abrasive particles in the softened particulate curable binder material. Alternatively, surface coatings can alter and improve the cutting characteristics of the resulting abrasive particle. Such surface coatings are described, for example, in U.S. Pat. Nos. 5,011,508 (Wald et al.); 3,041,156 (Rowse et al.); 5,009,675 (Kunz et al.); 4,997,461 (Markhoff-Matheny et al.); 5,213,591 (Celikkaya et al.); 5,085,671 (Martin et al.) and 5,042,991 (Kunz et al.).

### Particulate Binder

A particulate binder may be used in addition to metal particles and may be disposed on a first surface of a liner along with metal particles. Suitable optional particulate binders are described that can be present on the first liner in addition to the metal particles. For example, a particulate vitrifiable binder material may be a material that is a solid at room temperature (23° C.). Vitrifiable in this context means to become a solid either (i) through the curing (such as visible light cure or ultraviolet light cure) of a thermosetting liquid composition or (ii) by the cooling of a thermoplastic material, which can be semi-crystalline or non-crystalline. In some aspects, the particulate vitrifiable binder material may be mixed with abrasive particles, particularly when used as a size coat for a rigid substrate previously coated with a make coat. The particulate vitrifiable binder material preferably comprises organic vitrifiable polymer particles. The particulate vitrifiable polymers preferably are capable of softening on heating to provide a vitrifiable liquid capable of flowing sufficiently so as to be able to wet either an abrasive particle surface or the surface of an adjacent vitrifiable binder particle.

Suitable particulate vitrifiable binder materials are capable of providing satisfactory abrasive particle bonding and/or bonding to the make coat, the size coat or rigid substrate by being activated or rendered tacky at a temperature, which avoids causing heat damage or disfiguration to the rigid substrate to which it adhered. The particulate vitrifiable binder materials meeting these criteria may be selected from among certain thermosetting particle materials, thermoplastic particle materials and mixtures of thermosetting and thermoplastic particle materials, as described herein.

The thermosetting particle systems involve particles made of a temperature-activated thermosetting resin. Such particles are used in a solid granular or powder form. The initial effect of a temperature rise above the T_{g} temperature is a softening of the material into a flowable fluid-like state. This change in physical state allows the resin particles to mutually wet or contact the substrate, make coat, size coat and/or abrasive particles. Prolonged exposure to a sufficiently high temperature triggers a chemical reaction which forms a cross-linked three-dimensional molecular network. The solidified (cured) resin particle bonds abrasive particles to the abrasive article. Useful particulate vitrifiable binder materials may be selected from the group consisting of phenolic resins, phenoxy resins, polyester resins, copolyester resins, polyurethane resins, polyamide resins and mixtures thereof. Useful temperature-activated thermosetting systems include formaldehyde-containing resins, such as phenol formaldehyde, novolac phenolics and especially those with added crosslinking agent (e.g., hexamethylenetetramine), phenoplasts, and aminoplasts; unsaturated polyester resins; vinyl ester resins; alkyd resins, allyl resins; furan resins; epoxies; polyurethanes; cyanate esters; and polyimides. Useful thermosetting resins include the thermosetting powders disclosed, for example, in U.S. Pat. Nos. 5,872,192 (Kaplan et al.) and 5,786,430 (Kaplan et al.).

In the use of heat-activated thermosetting fusible powders, the particulate vitrifiable binder material is heated to at least its cure temperature to optimize the substrate and abrasive bonding. To prevent heat damage or distortion to the make or size coat, the cure temperature of the fusible thermosetting particle preferably will be below the melting point, and preferably below the T_{g} temperature, of these constituents.

Useful thermoplastic particulate vitrifiable binder materials include polyolefin resins such as polyethylene and polypropylene; polyester and copolyester resins; vinyl resins such as poly(vinyl chloride) and vinyl chloride-vinyl acetate copolymers; polyvinyl butyral; cellulose acetate; acrylic resins including polyacrylic and acrylic copolymers such as acrylonitrile-styrene copolymers; and polyamides (e.g., hexamethylene adipamide, polycaprolactum), and copolyamides.

In the case of semi-crystalline thermoplastic binder particles (e.g., polyolefins, polyesters, polyamides, polycaprolactum), it is preferred to heat the binder particles to at least their melting point whereupon the powder becomes molten to form a flowable fluid. Where noncrystallizing thermoplastics are used as the fusible particles of the bonding agent (e.g., vinyl resins, acrylic resins), the particles preferably are heated above the T_{g} temperature and rubbery region until the fluid flow region is achieved.

Mixtures of the above thermosetting and thermoplastic particle materials may also be used in the invention. Furthermore, the size of the particulate vitrifiable binder material is not particularly limited. In general, the average diameter of the particle is less than 1000 μm (0.039 in), preferably less than 500 μm (0.020 in), and more preferably less than 100 μm (0.0039 in). Generally, the smaller the diameter particles, the more efficient they may be rendered flowable because the surface area of the particles will increase as the materials are more finely divided.

Typically, the amount of particulate vitrifiable binder material used in the particulate vitrifiable binder-abrasive particle mixture (i.e., the “powder) generally will be in the range from 5 to 99 wt % particulate vitrifiable binder material, with the remainder 1 to 95 wt % comprising abrasive particles and optional fillers. Preferred proportions of the components in the mixture are 10 to 90 wt % abrasive particles and 90 to 10 wt % particulate vitrifiable binder material, and more preferably 50 to 85 wt % abrasive particles and 50 to 15 wt % particulate vitrifiable binder material.

The particulate vitrifiable binder material may include one or more optional additives selected from the group consisting of grinding aids, fillers, wetting agents, chemical blowing agents, surfactants, pigments, coupling agents, dyes, initiators, curing agents, energy receptors, and mixtures thereof. The optional additives may also be selected from the group consisting of potassium fluoroborate, lithium stearate, glass bubbles, inflatable bubbles, glass beads, cryolite, polyurethane particles, polysiloxane gum, polymeric particles, solid waxes, liquid waxes and mixtures thereof. Optional additives may be included to control particulate vitrifiable binder material porosity and erosion characteristics.

### Metal Modified Substrate

Suitable metal modified substrates may comprise a rigid or flexible substrate having thereon a layer of metal particles applied, for example, from a transfer article as described herein, and a first binder and, optionally, a second binder. Rigid substrates may be used to produce, for example, a lapping plate. As described herein, a layer of metal particles may be applied to a binder present on the substrate, for example, a first binder or a second binder, if present. Suitable binders and configuration of a metal modified substrate will be described.

A modified metal substrate may be prepared comprising the steps of providing a rigid substrate having opposing first and second surfaces; coating a first binder on the first surface of the rigid substrate; providing a metal particle transfer article as described herein; applying the metal particle transfer article to the first surface of the rigid substrate wherein the metal particles are in contact with the first binder; removing the first liner from the rigid substrate; and curing the first binder thereby securing the metal particles to the first surface of the rigid substrate. When a second liner is present on a transfer article, it is removed prior to applying the metal transfer article to the rigid substrate, thus leaving metal particles adhered to the first surface of the first liner. The first binder may be at least partially cured prior to applying the metal transfer article to the rigid substrate. A second binder may be coated on the first binder after curing the first binder before application of the metal particles. Pressure may be applied to a second surface of the first liner while it is disposed on the rigid substrate before the removing the first liner from the rigid substrate. A second surface of the rigid substrate may be coated with a first binder and a layer of metal particles may be applied from a second metal particle transfer article by contacting the metal particles with the first binder of the second surface. The first liner of the second transfer article may then be removed from the rigid substrate; and the first binder of the second surface may then be cured thereby securing the metal particles to the second surface of the rigid substrate. Optionally, a second binder may be present on the second surface as described with reference to the first surface of the substrate.

Specifically with reference to the figures, FIG. 2 shows a schematic cross-sectional view of a portion of an exemplary transfer method that can be used to make a metal modified substrate 40 of the present disclosure. Prior to transferring metal particles, a rigid substrate 20, having opposing first and second surfaces 20a and 20b respectively, has a first binder 22 (sometimes referred to as a “make coat”) coated on first surface 20a. A transfer article, for example, a transfer article of FIG. 1 may be used in the transfer method and, in this case, the second liner 14 of transfer article 10 of FIG. 1 has been removed to expose the metal particles 16 which remain on the first liner 12. The first liner 12 is disposed on the rigid substrate such that the metal particles 16 are in direct contact with the first binder 22, that is, the metal particles 16 are applied to the first binder 22. FIG. 2 shows that pressure is manually applied, using a lamination device 30, to the second surface 12b of the first liner 12 to promote the transfer of the metal particles 16 to the first binder 22. Other lamination techniques known to those skilled in the art can also be used. The metal particles 16 may penetrate the resinous binder 22 to come in direct contact with the first surface 20a of the rigid substrate. Thereafter the first liner is removed.

During the process of contacting the metal particles to the first binder, the resinous binder material should be in a tacky state. That is, the first binder should have sufficient tack to enable at least 20%, more preferably at least 50% and most preferably at least 70% of the metal particles to be transferred to the first binder. Depending on the type of first binder used, this tacky state can be achieved in a variety of ways. The optional particulate binder (which may function and be referred to as a “size coat”) and/or the optional abrasive particles may be disposed on the first binder at this point in the process.

The thickness of the first binder may be selected based on the size of the metal particles when multiple particle sizes are used. When multiple particle sizes are used, it is desirable to ensure that as many of the particles as possible are transferred to the first binder. To accomplish this transfer, a thicker binder layer may be used. Multiple transfer articles may be applied to the first binder multiple times to transfer more metal particles to a given area. Each application results in the transfer of particles of similar size. The smallest particles are held away from the binder layer by the larger particles already present in the binder layer. If the binder is thicker than the largest particles, typically all of the particles will tend to transfer.

When the first binder is formed from a solvent-based mixture containing a polymer, oligomer, monomer or combinations thereof, a tacky state may be inherent in the mixture. If not, it may be achieved by removing at least some of the solvent and, if required, at least partially curing the polymer, oligomer or monomer.

When the first binder is formed from a substantially solvent-free mixture containing a liquid polymer, oligomer, monomer or combinations thereof, the tacky state may be inherent in the mixture as well. If not, a tacky state may be achieved by heating or cooling the mixture or may be achieved by at least partially curing the polymer, oligomer, monomer or combinations thereof.

The first binder may also be formed from materials such as wax, menthol, or solder paste. The metal particles may then be secured by heating the first binder. In some instances, the menthol may partially or completely sublime or evaporate leaving only the metal particles on the substrate.

When the first binder is a particulate vitrifiable binder material, for example, as described above, so that the vitrifiable binder functions as the make coat, a tacky state may be achieved by heating the particulate vitrifiable binder material to a temperature near, at or above its glass transition (T_{g}) temperature and/or melting point to enable sufficient tack to develop. Advantageously, in this case, a uniform coating of the first binder on a substrate (such as rigid substrate 20 in FIG. 2) can be facilitated by heating the particulate vitrifiable binder material to a temperature above its glass transition temperature (Tg) and/or melting point causing a phase transition from the solid to liquid state. The heating can be done, for example, by placing the rigid substrate containing the particulate vitrifiable binder into an oven or other heating devices. Once in the liquid state, a uniform coating of the particulate vitrifiable binder material can be formed by techniques know to those skilled in the art, such as, for example, by manually spreading the now liquid material.

In one embodiment of the present invention, after metal particles are transferred to the first binder, it may be a least partially cured and/or partially vitrified, forming a solid or substantially solid (in the case of partial cure or partial vitrification) first binder. The term “vitrified” means generally that the binder has been converted into a glassy material, optionally by using a light source, such as a visible light or an ultraviolet light source. With a solid first binder, the metal particles are rigidly held therein, being substantially fixed in place, forming a metal modified substrate. When the first binder is thermoplastic resin, it can be vitrified by cooling below its melting point and/or glass transition temperature, Tg. When the first binder is a solvent-based mixture containing a polymer, oligomer, monomer or combinations thereof, it can be transformed to the solid state by removal of a majority of the solvent and/or by various methods of curing known to those skilled in the art. When the first binder is a substantially solvent-free mixture containing liquid polymer, oligomer, monomer or combinations thereof, it can be transformed to the solid state by various methods of curing known to those skilled in the art.

In another embodiment of the present disclosure, after metal particles and any particulate vitrifiable binder material, if used, are transferred to the first binder, it remains in a liquid state forming a non-fixed metal modified substrate. The viscosity of the first binder in the liquid state may be adjusted to the desired level by a variety of methods including, for example, heating, cooling, partially curing, and removing solvent (if present). In these embodiments, the metal particles are substantially free to move within the first binder. Preferably, when the metal modified substrate comprises a resinous binder in the liquid state forming a non-fixed article, no additional size coat or supersize coat is required.

In still another embodiment of the present disclosure, optional second binder (the size coat) and optional third binder (the super-size coat) may be applied to the first binder and the metal particles and, if present, the abrasive particles. The first binder can be in the solid state or liquid state during the size coat and/or super size coat process step. Preferably, the first binder is in the solid state. The size coat and/or super size coat can be applied by known coating techniques. Compositions of the make coat, size coat, and super-size coat are discussed in below in detail.

An embodiment of a metal modified substrate includes a metal modified substrate comprising a rigid substrate having a first and a second surface, a first binder on the first surface of the substrate, and a layer of metal particles disposed in the first binder. The phrase “a layer of metal particles disposed in” as used herein with reference to a binder, for example, a first binder, refers to the condition where the metal particles are at least partially present, embedded, or contained in the binder, that is, where at least a part of each of the metal particles is present in the binder.

In embodiments of the present disclosure, a layer of metal particles may comprise metal particles that are substantially the same as each other, i.e., wherein the metal particles have the same size, shape, composition, and/or properties (such as mechanical, optical, or electrical). Alternatively, the metal particles may differ from each other in terms of size, shape, composition, and/or properties (such as mechanical, optical, or electrical). In addition, the metal particles may be uniformly spaced or randomly spaced from each other.

Another embodiment includes a metal modified substrate comprising a rigid substrate having a first and a second surface, a first binder on the first surface of the substrate, a layer of metal particles disposed in the first binder, a first binder on the second surface of the substrate, and a layer of metal particles disposed in the first binder of the second surface so that the metal particles are applied to both sides of the rigid substrate forming a double-sided metal modified or textured rigid substrate.

An example is shown in FIG. 5 where double-sided metal modified substrate 80 is attached to tool platen 75, having a first surface 75a and a second surface 75b, by screws 73. Metal particles 76 are disposed in first binder 74a on first surface 72a of rigid substrate 72 and are disposed in first binder 74b of second surface 72b of rigid substrate 72. First binder 74a may be the same or different from first binder 74b. Metal particles 76 in first binder 74a may be the same or different from metal particles 76 in first binder 74b. The metal modified substrate 80 is removable for use on both sides and may be sufficiently thin and lightweight for shipping and recycling. Since two ductile metal coated surfaces may be present, twice the useful lifetime may be provided.

Yet another embodiment includes a metal modified substrate comprising a rigid substrate having a first and a second surface, a first binder on the first surface of the substrate, and a layer of metal particles disposed in the first binder, wherein the layer comprises at least two concentric regions on the first binder, wherein at least one concentric region comprises metal particles having a feature which differs from a feature of metal particles of at least one other concentric region. The term “concentric” refers to a sharing of the same center, axis or origin, i.e., the center of the substrate. Suitable shapes for concentric regions include circles, squares, and stars. Metal particles of at least one concentric region vary from metal particles of at least one other concentric region in terms of a characteristic, property, feature or combination thereof. For examples, metal particles may vary from one concentric region to another by particle composition, particle size, particle shape, particle packing (i.e., ordered/evenly spaced or random/irregularly spaced), particle areal density, particle wear rate, particle properties such as mechanical, optical or electrical, or combinations thereof.

In addition, within a region, the placement or location of metal particles may be such that the particles are uniformly spaced or randomly spaced. Also, within a region, metal particles may vary from each other in at least one characteristic, property, feature, or combination thereof, as described above, and yet the region may still be different from another region.

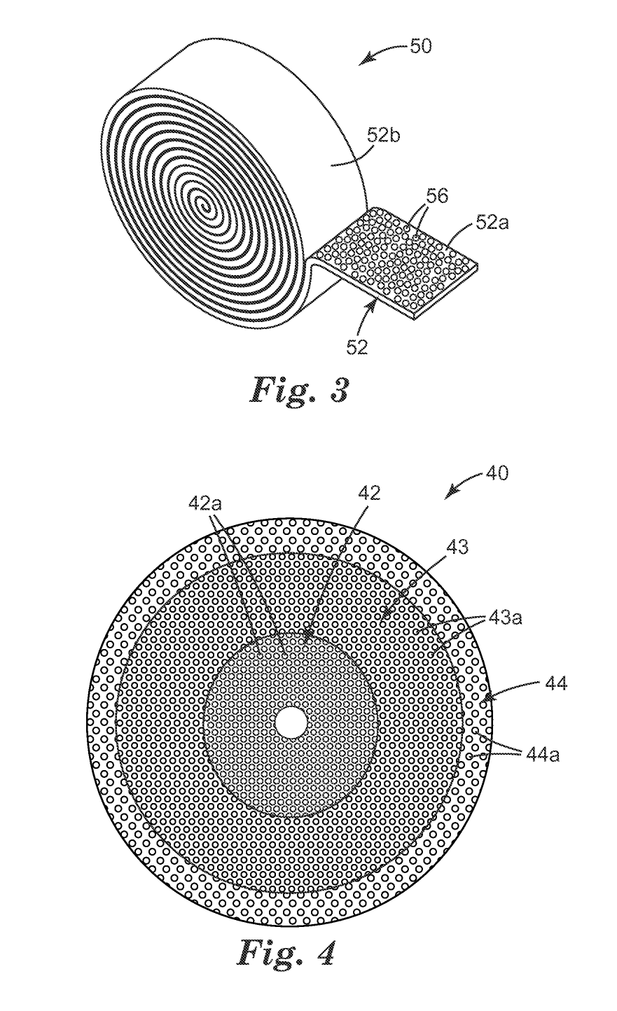

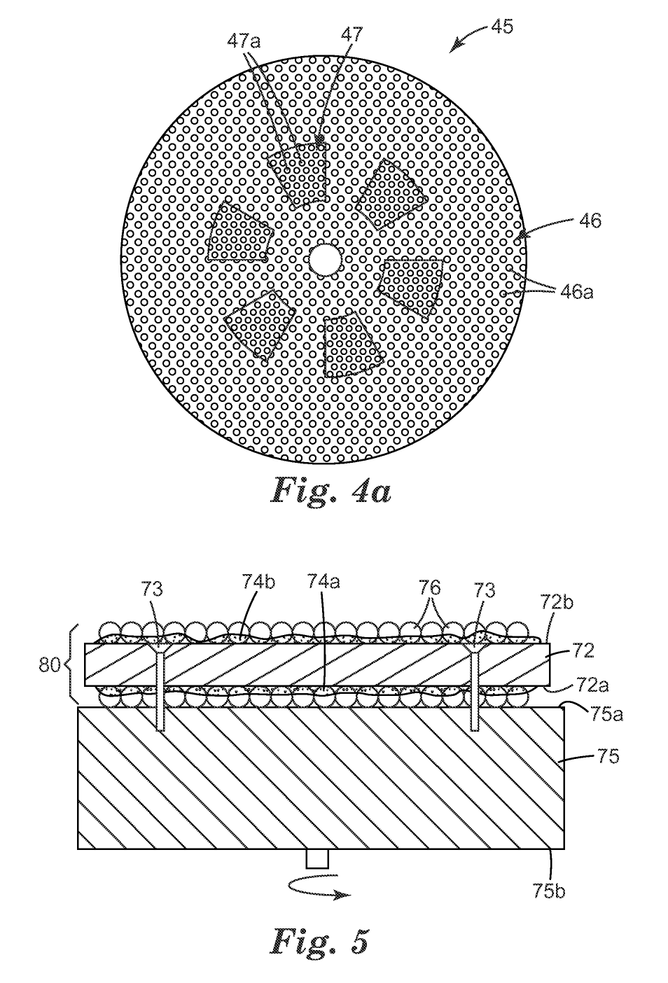

FIG. 4 depicts an exemplary metal modified substrate 40 with three concentric regions 42, 43, and 44 and comprises metal particles 42a, 43a, and 44 a, respectively. In this embodiment, each of the regions 42, 43, and 44 contain particles 42a, 43a, and 44 a, respectively, with a different areal density. Other embodiments may have at least two concentric regions where the metal particles in at least one region may vary from the metal particles of at least one other region as described above.

Concentric regions may be continuous circumferentially or discontinuous circumferentially. FIG. 4a depicts an exemplary metal modified substrate 45 with a continuous region 46, with metal particles 46a, and a discontinuous region 47, with metal particles 47a. Region 46 and region 47 as shown differ in terms of areal density of particles 46a and 47a, respectively. In another embodiment, a layer of metal particles may comprise at least one continuous region and at least one discontinuous region within the at least one continuous region where the metal particles of the at least one continuous region varies, as described above, from the metal particles of the at least one discontinuous region.

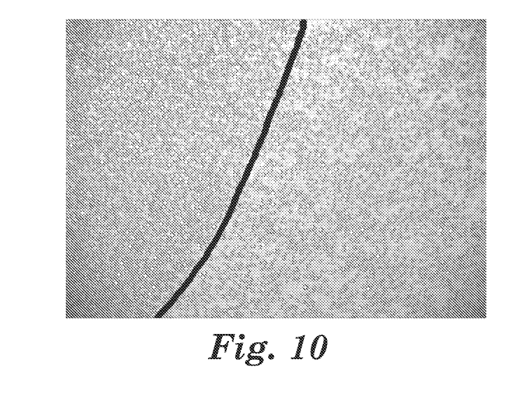

Another exemplary metal modified substrate, specifically a platen, comprising a layer of metal particles wherein the layer comprises at least two concentric regions is shown in FIG. 9. A closer view of the platen of FIG. 9 is shown in FIG. 10 which shows regions in the layer of metal particles with varying metal particle density.

The concentric regions are any of the articles or substrates described herein may be continuous, discontinuous, or separated, for example, by being connected by underlying layers. The concentration of metal particles may be diluted with non-metal particles of similar size. Suitable non-metal particles include organic resins or binders, inorganic ceramic or fillers.

The difference between concentric regions may be selected based on the intended use of a modified metal substrate. For example, the area or size of a particular concentric region as well as the areal density or wear resistance may be selected based on the intended use of a modified metal substrate.

Optionally, a second surface of the substrate may also comprise at least two concentric regions on its first binder.

The terms “areal density” and “bearing area” refer to the density of, for example, metal particles and, therefore, may be referred to as the percentage of metal particles in the surface plane of the concentric region. Assuming spheres, the highest bearing area will be spheres of the same size, very closely packed. A lower bearing area could be the same size spheres sparsely packed. A lower bearing area could also be provided by using fewer larger spheres and many smaller spheres, all closely packed.

The term “wear resistance” as used herein is defined as rate at which the surface plane of the concentric region changes and increased wear in a region may be measured by the distance out of planarity. Variations of wear resistance could be accomplished, for example, by using different metal particles in each region, that is, metal particles all of the same size where a fraction were tin and another fraction were copper or some other metal.

Different concentric regions may be developed by, for example, applying at least two transfer articles to a rigid substrate where a first transfer articles has different bearing areas or areal densities or different wear resistance than the second transfer article and each is applied to a different region of the rigid substrate. Also, by applying two equally coated transfer films to one region, the concentration of metal particles can be increased. This is most feasible when the metal particles are of varying size. Often very small metal particles do not transfer to the first binder layer, only the larger metal particles touch the first binder and adhere, while the smaller particles remain on the liner. Therefore, in a first application, the number of metal particles transferred might be small. A second application of an identical sheet of liner would transfer more, building up the concentration of metal particles in one region.

Alternatively, a transfer article can be produced as described herein where the article itself has at least two regions, where a first region has different bearing areas or areal densities or different wear resistance than a second region and then this transfer article can be applied to a rigid substrate.

Metal modified substrates of the present disclosure, for example, may have a bearing area that varies from inner diameter, ID, to outer diameter, OD, of the article so that the article may be resistant to irregular wear often associated with ductile platens of homogeneous bearing area from ID to OD. Irregular wear results in a loss of planarity of the platen and this in turn imparts a non planar geometry into the workpiece. Thus, the problem of non uniform wear problem can be addressed by providing a higher bearing area in the more wear prone areas of the abrasive article, for example, the platen, which is typically the center. Examples of commonly lapped/polished workpieces are silicon, sapphire, quartz and alumina titanium nitride. During polishing, for example, sapphire wafer polishing, a flat wafer surface is desired. Articles of the present disclosure begin in the planar state and can maintain improved planar wear by, for example, altering the wear properties on the article as described herein.

### First Binder (Make Coat) and Second Binder (Size Coat)

Materials that are useful as the first binder (the make coat) are also useful as the second binder (the size coat).

Examples of suitable first and or second binders include thermosetting resins, such as phenolic resins, aminoplast resins having pendant α,β-unsaturated carbonyl groups, urethane resins, acrylated urethane resins, epoxy resins, acrylated epoxy resins, ethylenically-unsaturated resins, acrylated isocyanurate resins, urea-formaldehyde resins, isocyanurate resins, bismaleimide resins, fluorene modified epoxy resins, and mixtures thereof.

Suitable epoxy resins have an oxirane ring and are polymerized by the ring opening. Such epoxide resins include monomeric epoxy resins and polymeric epoxy resins. These resins can vary greatly in the nature of their backbones and substituent groups. For example, the backbone may be of any type normally associated with epoxy resins and substituent groups thereon can be any group free of an active hydrogen atom that is reactive with an oxirane ring at room temperature. Representative examples of acceptable substituent groups include halogens, ester groups, ether groups, sulfonate groups, siloxane groups, nitro groups and phosphate groups. Examples of some preferred epoxy resins include 2,2-bis[4-(2,3-epoxy-propoxy)phenyl]propane (diglycidyl ether of bisphenol) and resins which are commercially available from Shell Chemical Co., Houston, Tex., under the trade designations EPON 828, EPON 1004, and EPON 1001F; and from Dow Chemical Co., Midland, Mich., under the trade designations DER 331, DER 332, and DER 334. Other suitable epoxy resins include glycidyl ethers of phenol formaldehyde novolac (from Dow Chemical Co.) under the trade designations DEN 431 and DEN 438.

Phenolic resins are used as resinous binders in abrasive article because of their thermal properties, availability, cost and ease of handling. There are two suitable types of phenolic resins, resole and novolac. Resole phenolic resins have a molar ratio of formaldehyde to phenol, of greater than or equal to 1:1, typically between 1.5:1.0 to 3.0:1.0. Novolac resins have a molar ratio of formaldehyde to phenol of less than one to one. Suitable examples of phenolic resins include those commercially available from Occidental Chemical Corp., Tonawanda, N.Y., under the trade designations DUREZ and VARCUM; from Monsanto Co., St. Louis, Mo., under the trade designation RESINOX; and from Ashland Chemical Inc., Columbus, Ohio, under the trade designations AROFENE and AROTAP.

The aminoplast resins which can be used as resinous binders have at least one pendant α,β-unsaturated carbonyl group per molecule or oligomer. These materials are further described in U.S. Pat. Nos. 4,903,440 (Larson et al.) and 5,236,472 (Kirk et al.).

Suitable ethylenically-unsaturated resins include both monomeric and polymeric compounds that contain atoms of carbon, hydrogen and oxygen, and optionally, nitrogen and the halogens. Oxygen or nitrogen atoms or both are generally present in ether, ester, urethane, amide, and urea groups. The ethylenically-unsaturated compounds preferably have a molecular weight of less than about 4,000 and are preferably esters made from the reaction of compounds containing aliphatic monohydroxy groups or aliphatic polyhydroxy groups and unsaturated carboxylic acids, such as acrylic acid, methacrylic acid, itaconic acid, crotonic acid, isocrotonic acid, maleic acid, and the like. Representative examples of ethylenically-unsaturated resins include those made by polymerizing methyl methacrylate, ethyl methacrylate, styrene, divinylbenzene, vinyl toluene, ethylene glycol diacrylate, ethylene glycol dimethacrylate, hexanediol diacrylate, triethylene glycol diacrylate, trimethylolpropane triacrylate, glycerol triacrylate, pentaerythritol triacrylate, pentaerythritol trimethacrylate, pentaerythritol tetraacrylate, or pentaerythritol tetramethacrylate, and mixtures thereof. Other ethylenically-unsaturated resins include those of polymerized monoallyl, polyallyl, and polymethallyl esters and amides of carboxylic acids, such as diallyl phthalate, diallyl adipate, and N,N-diallyladipamide. Still other polymerizable nitrogen-containing compounds include tris(2-acryloxyethyl)isocyanurate, 1,3,5-tri(2-methacryl-oxyethyl)-s-triazine, acrylamide, methylacrylamide, N-methylacrylamide, N,N-dimethyl-acrylamide, N-vinylpyrrolidone, and N-vinylpiperidone.

Acrylated urethanes are diacrylate esters of hydroxy terminated isocyanate extended polyesters or polyethers. Examples of acrylated urethanes which can be used in the make coats of the present invention include those commercially available from Radcure Specialties, Inc., Atlanta, Ga., under the trade designations, UVITHANE 782, CMD 6600, CMD 8400, and CMD 8805. Acrylated epoxies which can be used in the make coats are diacrylate esters of epoxy resins, such as the diacrylate esters of bisphenol A epoxy resin. Examples of acrylated epoxies include those available from Radcure Specialties, under the trade designations, CMD 3500, CMD 3600, and CMD 3700.

Bismaleimide resins which also can be used as resinous binder are further described in U.S. Pat. No. 5,314,513 (Miller et al.).

At least one of first and second binder can be system that contains a ternary photoinitiator system allowing for photocuring as disclosed in U.S. Pat. No. 4,735,632 (Oxman et al.). Other suitable first and second binders are disclosed in U.S. Pat. Nos. 5,580,647 (Larson et al.) and 6,372,336 B1 (Clausen).

At least one of the first and second binder can also contain optional additives, such as, for example, fillers (including grinding aids), fibers, lubricants, wetting agents, thixotropic materials, surfactants, pigments, dyes, antistatic agents, coupling agents, plasticizers, and suspending agents. The amounts of these materials are selected to provide the properties desired.

### Rigid Substrate

The term “rigid” describes a substrate that is at least self-supporting, i.e., it does not substantially deform under its own weight. By rigid, it is not meant that the substrate is absolutely inflexible. Rigid substrates may be deformed or bent under an applied load but offer very low compressibility. In one embodiment, a rigid substrate may comprise materials having a modulus of rigidity of 1×10⁶ pound per square inch (psi) (7×10⁴ kg/cm²) or greater. In another embodiment, a rigid substrate may comprise material having a modulus of rigidity of 10×10⁶ psi (7×10⁵ kg/cm²) or greater.

Suitable materials that can function as the rigid substrate include metals, metal alloys, metal-matrix composites, metalized plastics, inorganic glasses and vitrified organic resins, formed ceramics, and polymer matrix reinforced composites. An exemplary rigid substrate may be a cylindrical disk having a circumference and where at least the first binder and the metal particles are attached to the circumference, for example, a lapping platen. Lapping platens can vary greatly from a few inches in diameter to over 10 ft. in diameter. For example, rowbar lapping for a hard disk drive is often a 16″ diameter with an 8″ hole.

In one embodiment, the rigid substrate is substantially flat such that the height difference between its opposing first and second surfaces is less than 10 μm at any two points thereon. In another embodiment, the rigid substrate has a precise, non-flat geometry, such those that can be used for polishing lenses, for example, a concave or convex surface.

In another embodiment, at least the first surface of the rigid substrate is textured. Optionally, the second surface may be textured where at least one plane of the first surface (and optionally the second surface) is higher than another plane. The textured surface may be patterned or random. The highest plane or planes of the textured surface may be designated as the “receiving plane” since the highest plane or planes will receive the metal particles from a transfer article. The lower plane or planes may be designated as “recessed planes.”

### Flexible Substrates

Suitable flexible substrates include but are not limited to densified Kraft paper (such as those commercially available from Loparex North America, Willowbrook, Ill.), poly-coated paper such as polyethylene coated Kraft paper, and polymeric film. Suitable polymeric film includes polyester, polycarbonate, polypropylene, polyethylene, cellulose, polyamide, polyimide, polysilicone, polytetrafluoroethylene, polyethylenephthathalate, polyvinylchloride, and polycarbonate. Nonwoven or woven liners may also be useful.

A metal modified substrate comprising a flexible substrate may be prepared as described above with reference to a rigid substrate. The flexible substrate may be textured on a first and optionally a second surface as described with reference to a rigid substrate.

### Other Metal Modified Articles

A transfer article disclosed herein is also useful to prepare a non-fixed article. In contrast to the fixed system described above, the non-fixed system is one where the metal particles are disposed in a matrix that is typically not cured. The matrix holds the metal particles. Thus, in a non-fixed system, the metal particles are able to move during use, i.e., during a grinding process. An illustrative non-fixed abrasive system is optical polishing with pitch, where the pitch can be a viscous substance obtained as a residue in the distillation of organic materials, such as tars. The metal particles can be applied to the pitch using the transfer article disclosed herein. Publications that discuss optical polishing with pitch include the following: (i) R. Varshneya, J. E. DeGroote, L. L. Gregg, and S. D. Jacobs, “Characterizing Optical Polishing Pitch,” Optifab 2003 (SPIE, Bellingham, Wash., 2003), Vol. TD02, pp. 87-89; (ii) J. E. DeGroote, S. D. Jacobs, L. L. Gregg, A. E. Marino, J. C. Hayes, and R. Varshneya, “A Data Base for the Physical Properties of Optical Polishing Pitch,” in Optical Fabrication and Testing Digest (Optical Society of America, Washington, D.C., 2002), pp. 55-59; (iii) J. E. DeGroote, S. D. Jacobs, and J. M. Schoen, “Experiments on Magnetorheological Finishing of Optical Polymers,” in Optical Fabrication and Testing Digest (Optical Society of America, Washington, D.C., 2002), pp. 6-9; and (iv) J. E. DeGroote, S. D. Jacobs, L. L. Gregg, A. E. Marino, and J. C. Hayes, “Quantitative Characterization of Optical Polishing Pitch,” in Optical Manufacturing and Testing IV, edited by H. P. Stahl (SPIE, Bellingham, Wash., 2001), Vol. 4451, pp. 209-221, all of which are incorporated herein by reference.

### Articles Comprising A Metal Modified Substrate

An embodiment of the present disclosure includes articles comprising a metal modified substrate and further comprising abrasive particles embedded, for example, in the metal particles.

These articles may be produced by abrading a workpiece, either a sacrificial workpiece or the desired workpiece, in the presence of an abrasive slurry to embed the abrasive particles in the metal particles of the metal modified substrate.

In another embodiment, an abrasive-embedded article comprising a metal modified substrate, produced, for example, as described above (and which may be referred to as an abrasive-embedded metal lapping plate), may be used for the finer finishing of ultra hard materials such as sapphire, quartz, alumina titania carbide and gemstones. These embodiments as described may be suitable for replacing ductile metal lapping plates where precisely reproduced ductile surfaces are required, for example, fine finishing of ultra hard substrates such as sapphire or AlTiC.

For example, a workpiece may be attached to a stationary article that allows the workpiece to rotate, as described in Applied Physics A77, Jiang et al., 923-932 (2003), which is herein incorporated by reference. An abrasive-embedded article comprising a metal modified substrate, for example, a lapping plate, is then applied to the workpiece in the presence of an abrasive slurry, and the workpiece is then polished, abraded or finished. Alternatively, a metal modified substrate can be used in the presence of an abrasive slurry without first embedding abrasive particles in the metal particle to abrade a workpiece.

Suitable abrasive slurries for the slurries referred to herein include slurries comprising any of diamond, silica, alumina, and silicon carbide, and slurries described in PCT International Publication No. WO 2009/046296, incorporated herein by reference, as well as combinations thereof. Often, it is preferable to use a polycrystalline diamond slurry to polish, abrade or finish the desired workpiece.

Each patent and patent applications recited herein are incorporated by reference in its entirety.

### EXAMPLES

### Example 1

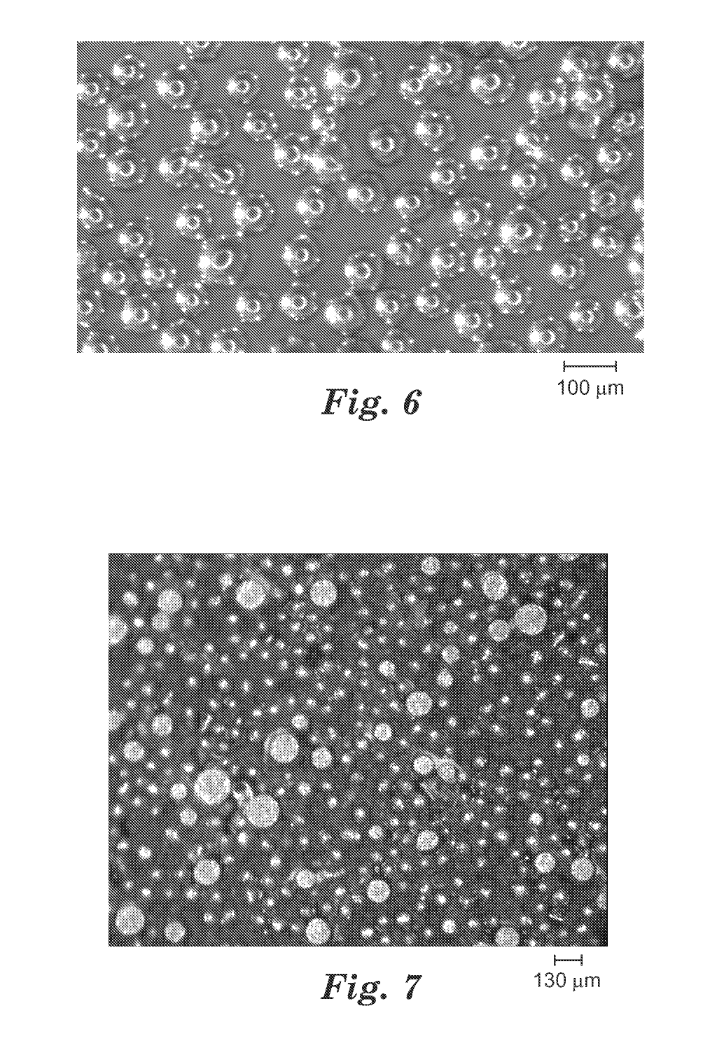

A metal transfer article was made as follows. Tin/bismuth metal beads (100-200 mesh) in the form of powder were obtained from Indium Corp of Utica N.Y. Approximately 2 g of the powder were spooned onto a 25″×25″ sheet of a fluorochemical release liner attached to a rigid aluminum sheet commercially available from 3M, St. Paul, Minn. under the trade designation “Scotchpak™ 4935.” The sheet was held at an angle and tapped allowing the powder to roll over the film and attach to the surface in a monolayer construction as shown in the photograph of FIG. 6. Additional powder was placed in bare spots and the process was repeated until the sheet was covered with beads and the excess powder was manually agitated off. A second sheet of Scotchpak™ 4935 was applied over the coating and rolled with rubber roller. The coating weight was approximately 0.25 g/in². The second Scotchpak™ 4935 sheet was removed along with the excess attached metal beads.

### Example 2

A metal transfer article was made in the same manner as Example 1 except that copper particles were used. The copper particles were 99% 200 mesh particles commercially available from Sigma-Aldrich having catalog no. 20778.

### Platen Coating

A 16″ diameter anodized aluminum platen with an 8″hole was coated with a thin layer of two part epoxy commercially available from 3M, St. Paul, Minn., under the trade designation “Scotchweld™ 1838.” This layer of epoxy was created by applying 3 g of the epoxy onto the platen and rolling the epoxy with a silicone roller in order to minimize the thickness of the epoxy layer yet have complete coverage of the platen surface to ensure adhesion of the particles to the platen and the epoxy. The transfer liner sheets prepared above were then gently applied to the epoxy with the particle side down. Care was taken so that the application was in one motion without sliding the film across the resin. The film was lowered to the platen holding the liner in two hands with the center drooping and touching the platen first. The rest of the film was then slowly lowered to allow the film to lie flat onto the resin and platen. The applied film was gently rolled with a rubber roller exerting only the weight of the roller as the pressure. The epoxy cured within 12 hours and the release liner was peeled from the surface. Once the release liner was removed, the surface was size coated. The size coating solution consisted of 4 g of a phenoxy resin (30% solids in 2-butanone) having the trade designation of “YP-50S’ obtained from Tohto Kasei Co. Lt. Inabata America Corp, New York, N.Y., 2.3 g of a polyester polyurethane resin (35% solution in methyl ethyl ketone (MEK), synthesized internally from neopentyl glycol 21% and poly caprolactone 29% and a methylene diisocyanate (MDI) 50%), 1.1 g of polymeric isocyanate commercially available from Bayer Chemical, Pittsburgh, Pa. under the trade designation “Mondur MRS” and 50 g of cyclohexanone. The platen surface was sprayed using an aerosol container in a well ventilated hood for about 60 seconds until the surface looked wet. The platen was allowed to dry and then baked at 70° C. for 8 hrs. The platen was then allowed to cool and mounted onto the tool.

### Polishing

A rough lapped 2″ sapphire wafer (C plane sapphire with a surface Ra between 0.2 and 0.4 microns) was mounted onto a 4″ diameter weighted cylindrical carrier. The sapphire wafer was held in place by a ridged 2.1″ non contacting carrier ring, such that the wafers were free to rotate, and loaded onto the yoke of a lapping tool commercially available from Lapmaster International, Mount Prospect, Ill., under the trade designation “Lapmaster 15” with a platen made from the transfer article of Example 1 (referred to as “Platen A”). A load 8 kg was applied to the wafer such that the effective pressure was 1.8 psi. An AlTiC conditioning ring of 4.5″ inner diameter and 5.5 outer diameter was run in a second yoke at 4 kg of total weight to apply added pressure to the diamond/metal interface and embedding the diamond. A slurry of 1 wt % 4-8 micron polycrystalline diamond commercially available from Tomei Corporation of America, Cedar Park, Tex. in 3 volume % of a coolant additive commercially available from Intersurface Dynamics, Bethel, Conn. under the trade designation “Challenge 543 HT”, and 96 volume % water, was dispensed at a setting of 0.9 or about 12.3 ml/min from a dispenser commercially available from Buehler, Lake Bluff, Ill. under the trade designation “PriMet Satellite dispenser.”

This process was repeated with a second sapphire wafer which was the same as the wafer described above and a second platen was used which was made from the transfer article of Example 2 (referred to as “Platen B”).

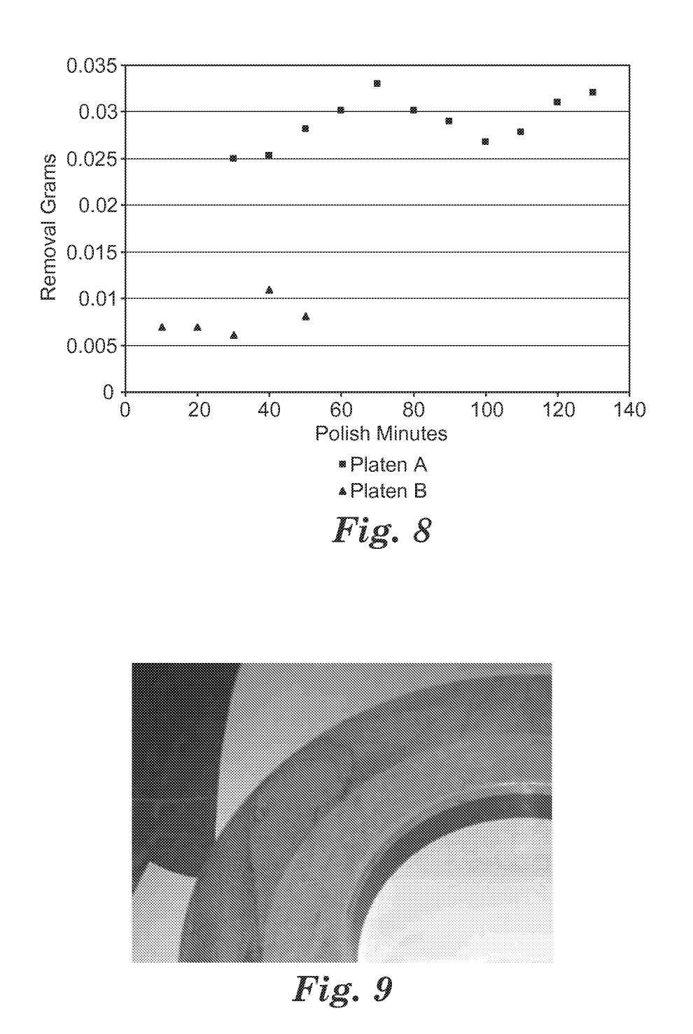

The platen speed was set at 40 rpms and the carrier rotation was set at 20 rpms for all measurements. The wafers were measured gravimetrically before and after a 10 minute run. FIG. 7 is a photograph showing the surface of a platen prepared with Example 1 after polishing. FIG. 8 is a chart showing removal in grams versus polishing minutes for Platens A and B.

What is claimed is:

1. A metal particle transfer article comprising:
a first liner having opposing first and second surfaces, wherein the first surface has a release value of less than about 700 gram per inch per ASTM D3330/D3330M-04; and
a layer of metal particles disposed on the first surface of the first liner.

2. The transfer article of claim 1 further comprising a second liner having opposing first and second surfaces,
wherein the first surface has a release value of less than about 700 gram per inch as measured according to ASTM D3330/D3330M-04, and
wherein the second liner is disposed on the layer of metal particles such that the first side of the second liner is in contact with the metal particles.

3. The transfer article of claim 2, wherein at least one of the first liner and second liner comprise a flexible backing and a release coating disposed on at least one of the first surface of the first and second liner, the release coating comprising a fluorine containing material, a silicon containing material, a fluoropolymer, a silicone polymer or a poly (meth)acrylate ester derived from a monomer comprising an alkyl (meth)acrylate having an alkyl group having 12 to 30 carbon atoms.

4. The transfer article of claim 2, wherein the flexible backing is selected from the group consisting of densified kraft paper, polycoated paper, and polymeric film.

5. The transfer article of claim 4, wherein the polymeric film is selected from the group consisting of polyester, polycarbonate, polypropylene, polyethylene, cellulose, polyamide, polyimide, polysilicone, and polytetrafluoroethylene.

6. The transfer article of claim 1, wherein the metal particles are any of tin, copper, indium, zinc, bismuth, lead, antimony, and silver and alloys thereof as well as combinations thereof.

7. The transfer article of claim 1, wherein the liner is textured.

8. A method of making a metal modified substrate comprising the steps of:
providing a rigid substrate having opposing first and second surfaces;
coating a first binder on the first surface of the rigid substrate;
providing a metal particle transfer article comprising
a first liner having opposing first and second surfaces, wherein the first surface has a release value of less than about 700 gram per inch per ASTM D3330/D3330M-04, and
a layer of metal particles disposed on the first surface of the first liner;
applying the metal particle transfer article to the first surface of the rigid substrate wherein the metal particles are in contact with the first binder;
removing the first liner from the rigid substrate; and
curing the first binder thereby securing the metal particles to the first surface of the rigid substrate.

9. The method of claim 8, wherein the transfer article further comprises a second liner having opposing first and second surfaces, the second surface has a release value of less than about 700 gram per inch as measured according to ASTM D3330/D3330M-04.

10. The method of claim 9, further comprising the step of removing the second liner from the transfer article leaving metal particles adhered to the first surface of the first liner prior to applying the metal transfer article to the rigid substrate.

11. The method of claim 8, wherein the first binder is at least partially cured prior to applying the metal transfer article to the rigid substrate.

12. The method of claim 8, wherein the first binder is substantially solvent free.

13. The method of claim 8 further comprising a step of coating a second binder on the first binder of the substrate after the curing the first binder.

14. The method of claim 8, wherein the rigid substrate is selected from the group consisting of metals, metal alloys, metal-matrix composites, metalized plastics, and polymer matrix reinforced composites.

15. The method of claim 8 further comprising a step of applying pressure to the second surface of the first liner while it is disposed on the rigid substrate before the removing the first liner from the rigid substrate.

16. The method of claim 8, wherein rigid substrate is substantially flat such that the height difference between the opposing first and second surfaces is less than 10 micrometer from any two points on the substrate.

17. The method of claim 8, wherein the rigid substrate has a precise, non-flat geometry.

18. The method of claim 8, wherein the rigid substrate is a cylindrical disk having a circumference and where at least the first binder and the metal particles are attached to the circumference.

19. The method of claim 8, wherein the metal particles are any of tin, copper, indium, zinc, bismuth, lead, antimony, and silver and alloys thereof as well as combinations thereof.

20. The method of claim 8, further comprising coating a first binder on the second surface of the rigid substrate;
providing a second metal particle transfer article comprising
a first liner having opposing first and second surfaces, wherein the first surface has a release value of less than about 700 gram per inch per ASTM D3330/D3330M-04, and
a layer of metal particles disposed on the first surface of the first liner;
applying the second metal particle transfer article to the second surface of the rigid substrate wherein the metal particles are in contact with the first binder;
removing the first liner from the rigid substrate; and
curing the first binder thereby securing the metal particles to the second surface of the rigid substrate.

21. A metal modified substrate comprising
a rigid substrate having a first and a second surface,
a first binder on the first surface of the substrate, and
a layer of metal particles disposed in the first binder.

22. A metal modified substrate comprising
a rigid substrate having a first and a second surface,
a first binder on the first surface of the substrate, and
a layer of metal particles disposed in the first binder,
wherein the layer comprises at least two concentric regions on the first binder, wherein at least one concentric region comprises metal particles having a feature which differs from a feature of metal particles of at least one other concentric region.

23. A metal modified substrate comprising
a rigid substrate having a first and a second surface,
a first binder on the first surface of the substrate,
a layer of metal particles disposed in the first binder of the first surface,
a first binder on the second surface of the substrate, and
a layer of metal particles disposed in the first binder of the second surface.

24. The metal modified substrate of claim 21 further comprising abrasive particles embedded in the metal particles.

25. The metal modified substrate of claim 22 further comprising abrasive particles embedded in the metal particles.

26. The metal modified substrate of claim 23 further comprising abrasive particles embedded in the metal particles.

27. The metal modified substrate of claim 24 wherein the abrasive particles are diamond.

28. The metal modified substrate of claim 21 wherein the substrate is textured.

29. A metal modified substrate comprising
A flexible substrate having a first and a second surface,
a first binder on the first surface of the substrate, and
a layer of metal particles disposed in the first binder.

30. A method of polishing a workpiece comprising
attaching a workpiece to a stationary article that allows the workpiece to rotate,
applying a metal modified substrate according to claim 21 to the workpiece in the presence of an abrasive slurry, and
abrading the workpiece.
